(19) United States
(12) Patent Application Publication
(10) Pub. No.: US 2009/0023882 A1
(43) Pub. Date: Jan. 22, 2009

(54) PROCESS FOR PREPARATION OF POLYISOBUTYLENE WHOSE CONTENT OF TERMINAL DOUBLE BONDS IS MORE THAN 50% FROM AN INDUSTRIAL C4 HYDROCARBON STREAM COMPRISING 1-BUTENE, 2-BUTENE AND ISOBUTENE

(75) Inventors: Phillip Hanefeld, Heidelberg (DE); Hans-Michael Walter, Freinsheim (DE); Matthias Kiefer, Ludwigshafen (DE); Helmut Mach, Heidelberg (DE); Thomas Wettling, Limburgerhof (DE); Marcus Sigl, Mannheim (DE); Markus Schubert, Ludwigshafen (DE); Jurgen Stephan, Mannheim (DE); Rainer Papp, Speyer (DE); Frank Poplow, Ludwigshafen (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF SE, Ludwigshafen (DE)

(21) Appl. No.: 12/278,590

(22) PCT Filed: Feb. 15, 2007
(86) PCT No.: PCT/EP07/51471

§ 371 Date: Aug. 7, 2008

(30) Foreign Application Priority Data
Feb. 23, 2006 (EP) 06110314.9

(51) Int. Cl. C08F 110/10

(52) U.S. Cl. 526/348.7; 585/820

(57) ABSTRACT

Preparation of polyisobutylene having a content of terminal double bonds of more than 50% by polymerizing isobutene using a polymerization catalyst customary therefor from a technical 1-butene-, 2-butene- and isobutene-containing C₄ hydrocarbon stream which may comprise up to 3000 ppm by weight, of 1,3-butadiene, by reducing the content of oxygenates in the C₄ hydrocarbon stream before the polymerization of the isobutene by contacting it with an inorganic adsorbent at a pressure of from 1 to 20 bar and a temperature of from 20 to 220° C.

The present invention relates to an improved process for preparing polyisobutylene having a content of terminal double bonds of more than 50% by polymerizing isobutene using a polymerization catalyst customary therefor from a technical 1-butene-, 2-butene- and isobutene-containing C₄ hydrocarbon stream which may still comprise small amounts of 1,3-butadiene. The present invention further relates to a process for reducing the content of oxygenates in a technical 1-butene-, 2-butene- and isobutene-containing C₄ hydrocarbon stream which may still comprise small amounts of 1,3-butadiene.

For the economically viable utilization of C₄ streams, as can be obtained, for example, from cracking processes or by dehydrogenation of butanes, various processes are already known. These starting streams typically comprise relatively large amounts of 1,3-butadiene, 1-butene, 2-butene and isobutene. In addition, significant amounts of butanes are often present. In order to achieve a process of maximum economic viability, the individual components each have to be converted to maximum-value saleable products without this impairing the other components. A particularly attractive option here is still the full or partial conversion of one C₄ component to another C₄ component which is sent to a more economically rewarding use. For this purpose, generally complex, multistage processes are required, in which the processing of the individual C₄ components is effected stepwise. Such processes are described, for example, in DE-A 101 18 634, EP-A 742 195 and EP-A 742 234.

Pure 1,3-butadiene is a sought-after monomer unit. Pure 1-butene is likewise a high-cost monomer unit, but also finds an economically significant outlet as a softener component and surfactant alcohol after hydroformylation to valeraldehyde and subsequent aldol condensation and hydrogenation to 2-propylheptanol. Isobutene serves as a starting material for fuel and lubricant additives after polymerization to polyisobutylene, as a fuel component after etherification with methanol to give methyl tert-butyl ether (MTBE), and as knock-resistant gasoline alkylate after dimerization to diisobutene and subsequent hydrogenation. In contrast, the direct chemical conversion of 2-butene has to date been of little industrial significance. A viable option here is olefin metathesis with ethene, which converts 2-butene to the valuable olefin unit propene.

EP-A 671 419 discloses a process for preparing polyisobutylene in which virtually halogen-free polyisobutylene having a high content of terminal double bonds (vinylidene groups) is obtained by boron trifluoride-catalyzed polymerization of the isobutene from a technical C₄ hydrocarbon stream whose 1-butene content has been depleted by a pretreatment step. An example mentioned for such a pretreatment step is selective hydroisomerization, which converts 1-butene to 2-butene.

WO 2005/028404 describes a process for preparing valeraldehyde by hydroformylating a C₄ stream which comprises 1-butene and at least 15% by weight of isobutene. The valeraldehyde can be converted further to 2-propylheptanol by aldol condensation and hydrogenation. The isobutene-enriched stream from the hydroformylation can be used, inter alia, to obtain polyisobutylene.

It was an object of the present invention to develop a process which enables maximum utilization with maximum economic viability of a technical C₄ stream to prepare polyisobutylene. This should be understood to mean especially that the conversion of isobutene in the polymerization to polyisobutene is as high as possible. For this purpose, it is necessary to efficiently remove the troublesome oxygen compounds in the C₄ streams used, i.e. oxygenates, especially water dissolved in the stream, before the isobutene polymerization. The polyisobutene obtained should be “highly reactive”, i.e. have a high fraction of terminal double bonds (vinylidene groups). Preferably, C₅ aldehydes should also be obtained here in a coproduction, which can in particular be converted further in an economically viable manner to 2-propylheptanol.

Accordingly, a process has been found for preparing polyisobutylene having a content of terminal double bonds of more than 50% by polymerizing isobutene using a polymerization catalyst customary therefor from a technical 1-butene-, 2-butene- and isobutene-containing C₄ hydrocarbon stream which may comprise up to 3000 ppm by weight of 1,3-butadiene, preferably up to 1000 ppm by weight of 1,3-butadiene, which comprises reducing the content of oxygenates in the C₄ hydrocarbon stream before the polymerization of the isobutene by contacting it with an inorganic adsorbent at a pressure of from 1 to 40 bar and a temperature of from −40 to +220° C., preferably from −10 to +150° C.

Oxygenates shall be understood here to mean all oxygen compounds which, owing to technical impurities or owing to the passage through preliminary workup, purification or synthesis stages, are present in or have become enriched in the C₄ stream to be used in the isobutene polymerization. Typical oxygenates are low molecular weight alcohols such as ethanol, low molecular weight carbonyl compounds such as acetone or acetaldehyde, and in particular water. “Low molecular weight” compounds shall be understood here to mean in particular organic oxygen compounds having from 1 to 4 carbon atoms.

The oxygenates are depleted preferably to 50% or less, especially to 20% or less, in particular to 5% or less, of the original value before the inventive treatment of the C₄ stream. After the inventive treatment of the C₄ stream, the absolute contents of oxygenates should in total be less than 100 ppm by weight, preferably less than 50 ppm by weight, in particular less than 10 ppm by weight. The oxygenates can be depleted to such an extent that the remaining residual amounts are no longer detectable by the customary analytical methods.

Preference is given here to working at temperatures of from 20 to 220° C., especially from 30 to 150° C., in particular from 40 to 80° C., or preferably, alternatively—depending on the nature of the inorganic adsorbent used and the remaining physical boundary conditions—at temperatures of from −40 to +100° C., especially from −30 to +60° C., in particular from −10 to +40° C., and preferably at a pressure of from 1 to 20 bar, especially from 1 to 5 bar, in particular from 1 to 2 bar, or preferably, alternatively—depending on the nature of the inorganic adsorbent used and the remaining physical boundary conditions—at a pressure of from 5 to 25 bar.

The process according to the invention and its further versions in the preferred embodiments illustrated in detail below are typically carried out continuously. However, a batchwise method is also possible in principle.

The mode of action of the inorganic adsorbent in the context of the present invention is apparently based on substantially full adsorption of the oxygenates under the given conditions. If appropriate, the inorganic adsorbent additionally also removes troublesome acetylenes and/or dienes (diolefins) from the C₄ stream. When fluorinated or chlorinated compounds stemming from the polymerization catalyst used are present in the C₄ streams, they are generally likewise removed; according to the teaching of the international application PCT/EP2007/050029, originating from European patent application 06 100 335.6, this is apparently done by absorptive splitting of the fluorinated or chlorinated compounds and binding of the fluorinated or chlorinated fragments on the surface of the inorganic adsorbent.

The inorganic adsorbent generally comprises oxides and salts such as halides, especially chlorides, sulfates, phosphates, carbonates or nitrates, of silicon, aluminum, zirconium, calcium and/or titanium which may have various dopants. Usually, aluminum oxides, aluminum halides, zirconium oxides, titanium oxides, calcium oxides, silicates, aluminosilicates, zeolites or mixtures thereof are used. Such adsorbents may also be present in the form of molecular sieves. Preference is given to working with aluminum oxide, zeolites and combinations thereof. The aluminum oxide used may in particular be doped with a base, for example an alkali metal hydroxide or alkaline earth metal hydroxide or an alkali metal cyanide or alkaline earth metal cyanide.

The inorganic adsorbent may have an acidic, a neutral or a basic character. Particularly suitable inorganic adsorbents are those which have, on their surface, not only acidic or weakly acidic regions but also basic or weakly basic regions; the latter are, for example, capable of covalently binding eliminated hydrogen fluoride or hydrogen chloride. Efficient removal of the hydrogen fluoride or hydrogen chloride prevents in particular the undesired acid-catalyzed structure isomerization of 1-butene to 2-butene.

In a preferred embodiment, the inorganic adsorbent comprises a zeolite with mean pore sizes of at least 5 Å, in particular from 5 to 15 Å. The mean pore size is laid down by the crystal structure of the zeolite and can be determined, for example, from X-ray structure data. The fluorinated compounds to be removed cannot diffuse easily into zeolites with relatively small mean pore sizes and are therefore adsorbed or split inadequately. The zeolites used are preferably essentially acid-free.

Preferred zeolites are selected from zeolite A, zeolite L, zeolite X and zeolite Y. Sodium zeolite A, or sodium zeolite A in which some or all of the sodium ions have been replaced by magnesium and/or calcium ions, is particularly preferred. A further particularly preferred zeolite is zeolite 10 A (commercially available, for example, from Zeochem under the name Z10-03), which already exhibits high absorptive performance at comparatively low temperatures.

In the zeolite treatment, it is suspected that the fluorinated or chlorinated compounds to be removed if appropriate are split and the fluorinated or chlorinated cleavage products such as hydrogen fluoride or hydrogen chloride are adsorbed on the zeolite or chemically bound by the cations present therein. In order to prevent undesired activation and/or structural change in the zeolite, it is possible to bind the hydrogen fluoride or hydrogen chloride by addition of an acid scavenger, for example of an amine or of a nitrile.

In a further preferred embodiment, the inorganic adsorbent comprises an aluminum oxide. Aluminum oxides are known as adsorbents for gases, liquids and solids, especially in chromatographic processes and methods. For the process according to the invention for removing fluorinated or chlorinated compounds, it is possible to use acidic, neutral or basic aluminum oxides; especially basic aluminum oxides are suitable for this purpose. Acidic aluminum oxides usually have a pH of from 3 to 6, typically of approx. 4. Neutral aluminum oxides usually have a pH of from 6 to 8, typically of approx. 7. Basic aluminum oxides usually have a pH of from 8 to 11, typically of approx. 9.5.

The aluminum oxides mentioned generally have pore volumes of from 0.5 to 1.5 ml/g, typically of approx. 0.9 ml/g, generally internal surface areas of from 70 to 250 m²/g, typically of approx. 150 m²/g, and generally particle sizes in the range from 30 to 300 μm, typically from 60 to 150 μm.

Further preferred inorganic adsorbents are a 13× molecular sieve or high-surface-area gamma-aluminum oxides (e.g. Selexsorb® from Almatis).

Before it is used, the inorganic adsorbent is appropriately activated by heating it to a temperature of at least 150° C., typically under reduced pressure, or by passing dry gaseous nitrogen or a comparable inert gas or gas mixture through it, typically at standard pressure and at a temperature of at least 150° C.

The technical C₄ hydrocarbon streams can be contacted with the inorganic adsorbent by all batchwise or continuous processes conceivable for this purpose. Typically, the generally gaseous or else—when working under pressure—liquid technical C₄ hydrocarbon streams are passed over the inorganic absorbent present in solid form, the absorbent being fixed essentially in its position in the apparatus or plant (absorber bed method). The adsorbent is preferably present in a fixed bed which is arranged in an adsorption column, through which the gas stream or liquid stream is passed. The adsorption column is preferably arranged vertically and is flowed through by the gas stream or liquid stream in the direction of gravity or preferably counter to gravity. It is also possible to use a plurality of adsorption columns connected in series.

In a preferred embodiment of the present invention, the inorganic adsorbent is present in the form of an adsorber bed which comprises aluminum oxides, aluminum halides, calcium oxides, zirconium oxides, titanium oxides, silicates, aluminosilicates, zeolites or mixtures thereof.

Particular preference is given to an embodiment in which at least two, preferably two, adsorber beds are used, each of which comprises aluminum oxides, aluminum halides, calcium oxides, zirconium oxides, titanium oxides, silicates, aluminosilicates, zeolites or mixtures thereof, and each of which is present alternately in adsorption or regeneration mode. These at least two adsorber beds preferably comprise the same inorganic adsorbent.

In a further particularly preferred embodiment, the technical C₄ hydrocarbon stream, before it is contacted with the inorganic adsorbent, is cooled at a pressure of from 1 to 40 bar, especially from 1 to 5 bar, to a temperature of less than 20° C., preferably less than 10° C., and water which separates out is removed. Typical conditions for this embodiment are cooling to from 0 to 7° C. at from 1 to 3 bar. The cooling is effected appropriately by means of heat exchangers with cooling liquid; the water separation is generally carried out on a fixed bed absorber by means of absorbent materials such as alkali metal or alkaline earth metal salts or zeolites.

The described treatment with the inorganic adsorbent to remove troublesome oxygenates and, if appropriate, additionally acetylenes and/or dienes (diolefins) can be combined in an advantageous manner with other customary purification processes, especially a pressure-swing process (pressure-swing adsorption) or a selective hydrogenation which in particular also removes residual traces of dienes (diolefins) and acetylenes.

Suitable technical C₄ hydrocarbon streams to be used in the polymerization of isobutene are in particular so-called raffinates (raffinate I or II). Such raffinates and analogous C₄ hydrocarbon streams can appropriately be prepared by four different methods:

In the first method, the C₄ stream is provided by
Ia) in step Ia, subjecting naphtha or other hydrocarbon compounds to a steamcracking or FCC process and, from the stream formed, removing a C₄ olefin mixture which comprises 1-butene, 2-butene, isobutene and more than 1000 ppm by weight of butadienes and, if appropriate, butynes, and
IIa) preparing from the C₄ an olefin mixture formed in step Ia a C₄ hydrocarbon stream (usually referred to as raffinate I) consisting essentially of 1-butene, 2-butene, isobutene and, if appropriate, butanes by hydrogenating the butadienes and butynes to butenes or butanes by means of selective hydrogenation, or removing the butadienes and butynes by extractive distillation to such an extent that the content of 1,3-butadiene is not more than 1000 ppm by weight.

In the second method, the C₄ stream is provided by
Ib) in step Ib, preparing from a hydrocarbon stream comprising butanes by dehydrogenation and subsequent purification, a C₄ olefin mixture which comprises 1-butene, 2-butene, isobutene and more than 1000 ppm by weight of butadienes and, if appropriate, butynes and, if appropriate, butanes, and
IIb) preparing from the C₄ olefin mixture formed in step Ib a C₄ hydrocarbon stream (usually referred to as raffinate I) consisting essentially of 1-butene, 2-butene, isobutene and, if appropriate, butanes by hydrogenating the butadienes and butynes to butenes or butanes by means of selective hydrogenation, or removing the butadienes and butynes by extractive distillation to such an extent that the content of 1,3-butadiene is not more than 1000 ppm by weight.

In the third method, the C₄ input stream (usually in the form of raffinate II) is provided by
Ic) preparing from methanol by dehydrogenation a C₄ olefin mixture (MTO process) which comprises 1-butene, 2-butene, isobutene and if appropriate butadienes, alkynes and if appropriate butanes, and
IIc) freeing the C₄ olefin mixture of butadienes or alkynes by distillation, selective hydrogenation or extractive distillation.

In the fourth method, the C₄ stream is provided by
Id) in step Id, preparing from a hydrocarbon stream comprising olefins by metathesis conversion and, if necessary, subsequent purification a C₄ olefin mixture which comprises 1-butene, 2-butene, isobutene and, if appropriate, butadienes and, if appropriate, butynes, and
IId) preparing from the C₄ olefin mixture formed in step Id a C₄ hydrocarbon stream consisting essentially of 1-butene, 2-butene, isobutene and, if appropriate, butanes by hydrogenating the butadienes and butynes to butenes or butanes by means of selective hydrogenation, or removing the butadienes and butynes by extractive distillation to such an extent that the content of 1,3-butadiene is not more than 1000 ppm by weight.

“2-Butene” is understood here to mean both cis- and trans-2-butene and mixtures thereof.

Raffinate II has essentially the same composition as raffinate I apart from the fact that raffinate II comprises smaller amounts of isobutene. Typically, raffinate II has amounts of less than 10% by weight, preferably less than 5% by weight, of isobutene. For this reason, this third method for providing the C₄ stream is indeed of relatively low importance for the process according to the invention.

The fourth method comprising steps Id and IId typically provides C₄ hydrocarbon streams which have an isobutene content of from 70 to 95% by weight, especially from 80 to 90% by weight; the remainder is essentially other butenes and other inert hydrocarbons. The starting material used as the hydrocarbon stream comprising olefins in step Id is generally an olefin mixture which consists essentially of ethylene and 2-butene and, in the metathesis conversion, as well as propene as the main product, also affords isobutene; after removal of the propene, the remaining hydrocarbon stream consists predominantly of isobutene.

The extractive distillation in step IIa, IIb, IIc or IId is preferably carried out with a butadiene-selective solvent which is selected from the class of the polar aprotic solvents, for example acetone, furfural, acetonitrile, dimethylacetamide, dimethylformamide or N-methylpyrrolidone.

The selective hydrogenation in step IIa, IIb, IIc or IId can be used for a further reduction of diolefins and acetylenic compounds, since these compounds would impair the subsequent process stages. In addition, the selective hydrogenation of a relatively large amount of 1,3-butadiene can also considerably increase the amount of linear monoolefins, which increases the production capacity of subsequent stages. Suitable catalysts and methods (for example relating to the hydrogen supply) allow the 1-butene to 2-butene ratio in the selective hydrogenation to be controlled within certain limits (known as hydroisomerization). Since there are attractive economic possible uses for the 1-butene in particular, 1-butene to 2-butene ratios of at least 1:3, preferably of at least 2:3, more preferably of more than 1:1, are pursued. The partial step of selective hydrogenation is preferably carried out in the liquid phase over a metal selected from the group of nickel, palladium and platinum on a support, preferably palladium on alumina, at a temperature of from 20 to 200° C., a pressure of from 1 to 50 bar, a volume flow rate of from 0.5 to 30 m³ of fresh feed per m³ of catalyst per hour, and a ratio of recycle to feed stream of from 0 to 30, with a molar ratio of hydrogen to diolefins of from 0.5 to 50.

When the content of 1,3-butadiene in the C₄ olefin mixture obtained in step Ia, Ib, Ic or Id is 5% by weight or more, the content of 1,3-butadiene is typically lowered by means of extractive distillation to a content between 1000 ppm by weight and 5% by weight, and the content of 1,3-butadiene is subsequently lowered further to 1000 ppm by weight or less by means of selective hydrogenation.

The technical C₄ hydrocarbon stream to be used in the polymerization of the isobutene preferably has a 1-butene to 2-butene volume ratio of from 3:1 to 1:3.

The content of 1,3-butadiene in the technical C₄ hydrocarbon stream to be used in the polymerization of isobutene is preferably less than 3000 ppm by weight, more preferably less than 1000 ppm by weight, in particular less than 100 ppm by weight.

In general, the technical C₄ hydrocarbon stream which is to be used in the polymerization of isobutene and is preferably a raffinate I stream comprises from 2 to 35% by weight, preferably from 5 to 30% by weight of butanes, from 10 to 40% by weight, preferably from 10 to 30% by weight of 2-butene, from 10 to 50% by weight, preferably from 15 to 35% by weight of 1-butene, from 30 to 50% by weight, preferably from 35 to 45% by weight of isobutene, and from 20 to 2000 ppm by weight, preferably from 20 to less than 1000 ppm by weight of butadienes.

In a preferred embodiment of the present invention, in the provision of the technical C₄ hydrocarbon stream used in the polymerization of isobutene, a hydroformylation of the C₄ hydrocarbon stream obtained from step IIa or IIb or IId is carried out as an additional step III in the presence of a customary hydroformylation catalyst with hydrogen and carbon monoxide, and the C₅ aldehydes formed are removed from the resulting C₄ hydrocarbon stream.

The hydroformylation can generally be carried out in the manner customary to the person skilled in the art. A good overview with numerous further references can be found, for example, in M. Beller et al., Journal of Molecular Catalysis A, 104, 1995, pages 17 to 85 or in Ullmann's Encyclopedia of Industrial Chemistry, 6^{th} edition, 2000 electronic release, Chapter “Aldehydes, Aliphatic and Araliphatic—Saturated Aldehydes”. The information given there enables the person skilled in the art to hydroformylate both the linear and the branched alkenes.

The hydroformylation of 1-butene to n-valeraldehyde, the main constituent in the C₅ aldehyde mixture formed in the hydroformylation stage of the process according to the invention, is described in particular in EP-A 016 286.

In the hydroformylation, n-valeraldehyde (n-pentanal) is prepared under transition metal catalysis from the 1-butene with addition of synthesis gas (carbon monoxide-hydrogen mixture, typically in a volume ratio of from 3:1 to 1:3, preferably from 1.5:1 to 1:1.15). Structurally isomeric C₅ aldehydes can form in small amounts from other components of the C₄ starting stream.

The catalysts used for the hydroformylation reaction are generally rhodium complexes with phosphorus ligands. The phosphorus ligands are typically a mono- or diphosphine, preferably a triarylphosphine, more preferably triphenylphosphine. The hydroformylation reaction is carried out typically at temperatures of from 50 to 150° C., preferably from 70 to 120°C., and pressures of from 5 to 50 bar, preferably from 10 to 30 bar.

The C₄ stream after the hydroformylation (usually referred to as raffinate 1P) comprises typically from 2 to 25% by weight, preferably from 5 to 20% by weight of butanes, from 25 to 70% by weight, preferably from 35 to 55% by weight of 2-butene, from 1 to 15% by weight, preferably from 3 to 10% by weight of 1-butene, from 30 to 55% by weight, preferably from 35 to 50% by weight of isobutene and from 20 to 1000 ppm by weight, preferably from 20 to less than 300 ppm by weight of butadienes. The volume ratio of 1-butene to 2-butene in this C₄ stream is typically from 1:3 to 1:60.

The conversion of the 1-butene in the hydroformylation reaction described is preferably greater than 80%.

In a further preferred embodiment, the process according to the invention comprises the further conversion of the C₅ aldehydes formed in the hydroformylation reaction of step III to 2-propylheptanol. This is because the conversion of the C₅ aldehydes to 2-propylheptanol, which constitutes an economically significant outlet as a plasticizer component and surfactant alcohol, means a significant increase in added value in the synthesis sequence.

The main constituent of the C₅ aldehyde mixture formed in the hydroformylation of step III is n-valeraldehyde which is appropriately converted by aldol condensation and subsequent hydrogenation to 2-propylheptanol. Further constituents are mainly C₅ aldehydes isomeric to n-valeraldehyde, such as 2-methylbutanal and 3-methylbutanal. The reaction sequence of the industrial scale conversion of n-valeraldehyde to 2-propylheptanol is known to the person skilled in the art, for example from U.S. Pat. No. 2,921,089 and U.S. Pat. No. 4,426,542, and is effected typically in four steps: (i) aldol condensation by means of aqueous alkali metal hydroxide, (ii) removal of the aldol condensate formed from the aqueous phase by phase separation, (iii) hydrogenation by means of a hydrogenation catalyst suitable therefor and, if appropriate, (iv) purification of the resulting 2-propylheptanol by fractional distillation, preferably under reduced pressure.

In step (i), the n-valeraldehyde reacts in aqueous alkali metal hydroxide solution which typically has a concentration of alkali metal hydroxide of from 1 to 10% by weight, for example in from 2 to 5% by weight aqueous sodium hydroxide solution, relatively rapidly to give the corresponding aldol condensate (2-propyl-2-heptenal). Bases other than alkali metal hydroxide can likewise be used, for example alkali metal cyanides. For this purpose, temperatures of from 50 to 200° C., especially from 80 to 150° C., in particular from 90 to 110° C., are generally employed. The pressure is in principle uncritical for the reaction; it is possible to work at atmospheric pressure, below atmospheric pressure or at slightly elevated pressures. The aldol condensation is preferably carried out at pressures below 0.5 MPa. The reaction is virtually complete after only a few hours; typical reaction times are from 0.5 to 5 hours, in particular from 1 to 3 hours. The conversions are generally higher than 99%. The reactor used in step (i) may, for example, be a mixing pump, a column with random packings or a stirred tank.

In step (ii), the aldol condensate formed is separated as the upper organic phase from the lower aqueous phase in a customary phase separation apparatus. After addition of fresh alkali metal hydroxide, the aqueous phase can be recycled partly back into step (i).

In step (iii), the aldol condensate is hydrogenated with hydrogen in the presence of a hydrogenation catalyst suitable therefor, in particular of a heterogeneous hydrogenation catalyst, for example of a nickel-containing, of a cobalt-containing or of a copper-containing hydrogenation catalyst such as Raney nickel or cobalt on kieselguhr, at temperatures of typically from 120 to 250° C., in particular from 150 to 200° C., and hydrogen pressures customary for this purpose, especially at from 0.5 to 20 MPa, in particular from 1 to 10 MPa. Often, small amounts of water are added as a promoter for the hydrogenation. The hydrogenation may be carried out in one stage, for example in fixed bed mode with a nickel-containing hydrogenation catalyst, or in several stages, for example in gas-liquid mode or in liquid-liquid mode. Typically, the hydrogenation is carried out in an autoclave or another pressure vessel. The conversions are typically virtually at 100%, the selectivity generally at more than 99%.

When the 2-propylheptanol thus obtained is to be purified in a subsequent step (iv), a fractional distillation is carried out, preferably under reduced pressure, for example at pressures of from 1 to 70 kPa.

The polymerization of the isobutene itself can be carried out by the inventive conditioning step by means of an inorganic adsorbent as described above, generally in the customary manner known to those skilled in the art. The prior art which is representative in this regard is reflected, for example, by the documents U.S. Pat. No. 4,152,499, U.S. Pat. No. 4,605,808, U.S. Pat. No. 5,068,490, EP-A 489 508 and EP-A 671 419.

The polymerization catalyst used is preferably a homogeneous or heterogeneous catalyst from the class of the Brønsted or Lewis acids. In particular, the catalyst is boron trifluoride or boron trifluoride complexes such as boron trifluoride etherates, e.g. boron trifluoride diethyl etherate, or boron trifluoride-alcohol complexes, for example with ethanol, isopropanol or sec-butanol. Tin tetrachloride too, either alone or together with mineral acids or alkyl halides such as tert-butyl chloride as cocatalysts, and also aqueous aluminum chloride, may be used as polymerization catalysts.

The polymerization catalyst is generally used in amounts of from 0.001 to 10% by weight, in particular from 0.01 to 1% by weight, based on the isobutene content of the C₄ stream used.

The isobutene polymerization is carried out typically at temperatures of from −100 to +100° C., especially from −50 to +25° C., in particular from −35 to +5° C. Appropriately a pressure of from 10 to 5000 kPa is employed.

The polymerization reaction is appropriately terminated by adding excess amounts of basic material, for example gaseous or aqueous ammonia or aqueous alkali metal hydroxide solution such as sodium hydroxide solution. After unconverted C₄ monomers have been removed, the crude polymerization product is typically washed repeatedly with distilled or deionized water, in order to remove adhering inorganic constituents. To achieve high purities or to remove undesired low and/or high molecular weight fractions, the polymerization product can be fractionally distilled under reduced pressure.

The polymerization stage described achieves essentially halogen-free polyisobutylene having a high content of terminal double bonds (vinylidene groups) of more than 50%, preferably at least 65%, especially at least 75%, in particular at least 85%. The residual content of halogen, which is typically present as fluoride or chloride depending on the polymerization catalyst used, is usually less than 10 ppm by weight, in particular less than 5 ppm by weight for fluorine, or usually less than 50 ppm by weight, in particular less than 20 ppm by weight for chlorine.

The polyisobutylene thus prepared generally has a number-average molecular weight Mₙ of from 500 to 5000, especially from 700 to 3500, in particular from 750 to 3000, in each case measured by gel permeation chromatography (GP). The polydispersity (D=M_{w}/Mₙ) is typically less than 2.5, preferably less than 2.0 and especially less than 1.8.

The relative isobutene content in the C₄ stream used for the isobutene polymerization is reduced by the polymerization normally by at least 40%, usually by at least 70%, in particular by at least 85%.

After the isobutene polymerization, the C₄ stream comprises typically from 15 to 55% by weight, preferably from 15 to 45% by weight of butanes, from 15 to 75% by weight, preferably from 20 to 70% by weight of 2-butene, from 5 to 45% by weight, preferably from 8 to 35% by weight of 1-butene, from 1 to 10% by weight, preferably from 1 to 5% by weight of isobutene, and from 20 to 1000 ppm by weight, preferably from 20 to less than 300 ppm by weight of butadienes.

A further preferred embodiment of the present invention comprises, after the polymerization of the isobutene, a metathesis reaction in which the 2-butene-rich C₄ residual stream removed from the isobutene polymerization is contacted with ethane in the presence of a customary metathesis catalyst and the propene is removed from the propene-containing hydrocarbon stream formed.

In order also to be able to utilize the 2-butene still present in the 2-butene-rich C₄ residual stream in an economically viable manner, it can be converted to the higher-value monomer propene in a metathesis stage. To this end, ethene is added stoichiometrically (based on 2-butene) or ethene is added in excess. Although any 1-butene or isobutene still present in the stream reacts partly, likewise to form higher olefins (C₅ and C₆), these can be discharged or else recycled into the metathesis, so that only a small net conversion, if any, arises.

If the propene-containing hydrocarbon stream formed in the metathesis stage comprises C₅ and C₆ olefins, they are removed from the propene and recycled into the metathesis stage typically at least to the extent that the molar ratio of the sum of the unrecycled C₅ and C₆ olefins to propene is not more than 0.2:1.

Unconverted 2-butene and ethene can also, if appropriate, likewise be recycled into the metathesis stage, since the metathesis reaction is an equilibrium reaction.

Both for the metathesis reaction described with the 2-butene-rich C₄ residual stream removed from the isobutene polymerization and for the metathesis reaction of a hydrocarbon stream comprising olefins to provide a technical C₄ hydrocarbon stream for the isobutene polymerization, two different catalyst types are useful in principle: rhenium-containing catalysts which are operated at temperatures in the range from 30 to 150° C., preferably in the range from 35 to 110° C., and tungsten-containing, rhenium-free catalysts which are operated in the gas phase at temperatures of from 200 to 600° C., preferably from 220 to 450° C.

The rhenium-containing catalysts comprise preferably at least 1% by weight of Re in oxidic form on a support which consists to an extent of at least 75% by weight of a high-surface area alumina, especially gamma-alumina. Preference is given in particular to catalysts which have an Re content of from 5 to 12% by weight and are supported on pure gamma-alumina. To increase the activity, the catalysts may also additionally comprise dopants, for example oxides of Nb, Ta, Zr, Ti, Fe, Mn, Si, Mo or W, or phosphate or sulfate. The catalysts preferably have surface areas of at least 100 m²/g and pore volumes of at least 0.3 ml/g.

Suitable tungsten-containing, rhenium-free catalysts comprise preferably at least 3% by weight of W, at least partly in oxidic form, on a support selected from aluminas, aluminosilicates, zeolites or in particular SiO₂. The catalysts preferably have a surface area of at least 50 m²/g and a pore volume of at least 0.3 ml/g. The activity or isomerization activity can be improved by suitable doping, for example by alkali metal and alkaline earth metal compounds, TiO₂, ZrO₂, HfO₂ or compounds or elements from the group of Ag, Sb, Mn, W, Mo, Zn and Si. If a further increase in the 1-butene content is desired in the metathesis, it is also possible to admix an isomerization catalyst, for example an alkaline earth metal oxide, with the tungsten-containing, rhenium-free catalyst. This leads to the generation in the metathesis, in addition to propene, also of an additional amount of 1-butene which can in turn, after distillative removal, be fed to the hydroformylation stage, and increases the capacity here.

It is known to the person skilled in the art that all types of metathesis catalysts have to be oxidatively regenerated regularly. To this end, either a structure with fixed beds and at least two reactors is selected, of which at least one reactor is always in regeneration mode, or a moving bed process can alternatively be practiced, in which deactivated catalyst is discharged and regenerated externally.

Especially in the case of use of a rhenium-containing catalyst, the embodiment of reactive distillation is also useful for the metathesis reaction described with the 2-butene-rich C₄ residual stream removed from the isobutene polymerization, in which the metathesis catalyst is placed directly in the distillation column. This embodiment is suitable in particular in the presence of relatively large amounts of 1-butene in the starting stream. In this case, unconverted ethene, propene and 1-butene are removed via the top; the heavier olefins remain together with the catalyst in the bottoms. If appropriate, discharge of inerts, for instance butanes, has to be ensured. This specific type of reaction control allows the conversion of 2-butene to propene without the 1-butene content being altered.

The propene-containing hydrocarbon stream formed in the metathesis stage with the 2-butene-rich C₄ residual stream removed from the isobutene polymerization is worked up preferably by means of distillation. The distillative separation of the can be effected in a plurality of distillation stages connected in series, or the propene-containing hydrocarbon stream formed in the metathesis stage can be fed at a suitable point into the separation apparatus which splits the hydrocarbon mixture formed in the steamcracker into individual fractions.

If a polymer is to be prepared from the propene in a subsequent step, the propene is purified further by customary methods, in order that the so-called polymer-grade specification is achieved with regard to impurities.

The inventive conditioning step of the technical C₄ hydrocarbon stream used in the isobutene polymerization by means of an inorganic adsorbent, as described above, which removes or at least greatly depletes troublesome oxygenates and, if appropriate, also acetylenes and/or dienes (diolefins), is responsible for the good product quality of the polyisobutylene and also for a high yield of propene in the metathesis reaction which follows if appropriate. After the conditioning step, the absolute contents of oxygenates should in total be less than 100 ppm by weight, preferably less than 50 ppm by weight, in particular less than 10 ppm by weight. After the conditioning step, the absolute contents of acetylene and/or dienes (diolefins) should in total be less than 300 ppm by weight, preferably less than 150 ppm by weight, in particular less than 100 ppm by weight.

The depletion of the troublesome oxygenates in technical C₄ hydrocarbon streams described can in principle be undertaken in any such C₄ stream, no matter what it is used for thereafter. The present invention therefore also provides a process for reducing the content of oxygenates in a technical 1-butene-, 2-butene- and isobutene-containing C₄ hydrocarbon stream which may comprise up to 3000 ppm by weight, preferably up to 1000 ppm by weight, of 1,3-butadiene, which comprises contacting the C₄ hydrocarbon stream with an inorganic adsorbent at a pressure of from 1 to 40 bar and a temperature of from −40 to +220° C., preferably from −10 to +150° C.

However, this process is preferably employed for a C₄ hydrocarbon stream which, after the contacting with the inorganic adsorbent, is used to prepare polyisobutylene having a content of terminal double bonds of more than 50% by polymerizing isobutene using a polymerization catalyst customary for this purpose.

The examples which follow are intended to illustrate the present invention, but without restricting it.

### EXAMPLES

In a batchwise stirred reactor, polymerizations of a technical isobutene-containing C₄ hydrocarbon stream of the composition 45% by weight of isobutene, 22% by weight of 1-butene, 12% by weight of 2-butene and 21% by weight of butanes, which comprise different oxygenate impurities in each case, were carried out at −25° C. by means of a boron trifluoride-methanol catalyst complex customary for this purpose to give polyisobutene. Before the polymerization, the C₄ hydrocarbon stream was in each case diluted with the same volume of n-hexane. The catalyst concentration in the polymerization medium was in each case 0.5% by weight. The resulting polyisobutene in each case had a number-average molecular weight of approx. 1000.

In accordance with the invention, the oxygenate impurities were in each case removed by passing the C₄ hydrocarbon stream at 20° C. and 5 bar through an adsorption column (absorber bed mode) which had been filled with commercial basic aluminum oxide (pH 9.5; pore volume approx. 0.9 ml/g; internal surface area approx. 150 m²/g; particle size from 60 to 150 μm) as an inorganic adsorbent, to such an extent that they were no longer detectable analytically by the customary analytical methods (B tests). The conversion of isobutene was in each case determined gravimetrically. For comparison, polymerizations were carried out in each case (A tests), in which the C₄ hydrocarbon stream which still comprised the oxygenate impurity was used. The table which follows shows the results of the determinations.

| | | | Isobutene |
|---|---|---|---|
| | | [ppm | conversion |
| Test No. | Oxygenate in the C₄ stream | by wt.] | [%] |
| 1 A | Pentanal | 20 | 63 |
| 1 B | After removal of the pentanal | | 72 |
| 2 A | Butanal | 35 | 54 |
| 2 B | After removal of the butanal | | 71 |
| 3 A | 1-Butanol | 50 | 17 |
| 3 B | After removal of the 1-butanol | | 70 |
| 4 A | Isobutanol | 35 | 61 |
| 4 B | After removal of the isobutanol | | 72 |
| 5 A | Water | 95 | 33 |
| 5 B | After removal of the water | | 71 |

After the inventive reduction in the oxygenate content in the C₄ stream to virtually no longer detectable residual amounts, the isobutene polymerization proceeds up to a conversion of from 70 to 72%, whereas significantly lower conversions are achieved in the presence of these oxygenate impurities.

1-11. (canceled)

12. A process for preparing polyisobutylene having a content of terminal double bonds of more than 50% by polymerizing isobutene using a polymerization catalyst customary therefor from a technical 1-butene-, 2-butene- and isobutene-containing C₄ hydrocarbon stream which may comprise up to 3000 ppm by weight of 1,3-butadiene, which comprises reducing the content of oxygenates in the C₄ hydrocarbon stream before the polymerization of the isobutene by contacting it with an inorganic adsorbent at a pressure of from 1 to 40 bar and a temperature of from −40 to +220° C.

13. The process according to claim 12, wherein the inorganic adsorbent is present in the form of an adsorber bed which comprises aluminum oxides, aluminum halides, calcium oxides, zirconium oxides, titanium oxides, silicates, aluminosilicates, zeolites or mixtures thereof.

14. The process according to claim 12, wherein the technical C₄ hydrocarbon stream, before it is contacted with the inorganic adsorbent, is cooled at a pressure of from 1 to 40 bar to a temperature of less than 20° C. and water which separates out is removed.

15. The process according to claim 12, wherein the technical C₄ hydrocarbon stream used in the polymerization of the isobutene is provided by
Ia) subjecting naphtha or other hydrocarbon compounds to a steamcracking or FCC process and, from the stream formed, removing a C₄ olefin mixture which comprises 1-butene, 2-butene, isobutene and more than 1000 ppm by weight of butadienes and, optionally butynes, and
IIa) preparing from the C₄ olefin mixture formed in step Ia a C₄ hydrocarbon stream consisting essentially of 1-butene, 2-butene, isobutene and, optionally butanes by hydrogenating the butadienes and butynes to butenes or butanes by means of selective hydrogenation, or removing the butadienes and butynes by extractive distillation to such an extent that the content of 1,3-butadiene is not more than 1000 ppm by weight.

16. The process according to claim 12, wherein the technical C₄ hydrocarbon stream used in the polymerization of isobutene is provided by
Ib) preparing from a hydrocarbon stream comprising butanes by dehydrogenation and subsequent purification, a C₄ olefin mixture which comprises 1-butene, 2-butene, isobutene and more than 1000 ppm by weight of butadienes and, optionally butynes and butanes, and
IIb) preparing from the C₄ olefin mixture formed in step Ib a C₄ hydrocarbon stream consisting essentially of 1-butene, 2-butene, isobutene and, optionally butanes by hydrogenating the butadienes and butynes to butenes or butanes by means of selective hydrogenation, or removing the butadienes and butynes by extractive distillation to such an extent that the content of 1,3-butadiene is not more than 1000 ppm by weight.

17. The process according to claim 12, wherein the technical C₄ hydrocarbon stream used in the polymerization of the isobutene is prepared by
Id) preparing from a hydrocarbon stream comprising olefins by metathesis conversion and, optionally, subsequent purification a C₄ olefin mixture which comprises 1-butene, 2-butene, isobutene and, optionally, butadienes and butynes, and
IId) preparing from the C₄ olefin mixture formed in step Id a C₄ hydrocarbon stream consisting essentially of 1-butene, 2-butene, isobutene and, optionally, butanes by hydrogenating the butadienes and butynes to butenes or butanes by means of selective hydrogenation, or removing the butadienes and butynes by extractive distillation to such an extent that the content of 1,3-butadiene is not more than 1000 ppm by weight.

18. The process according to claim 15, wherein, when the content of 1,3-butadiene in the C₄ olefin mixture obtained in step Ia is 5% by weight or more, the content of 1,3-butadiene is lowered by means of extractive distillation to a content between 1000 ppm by weight and 5% by weight, and the content of 1,3-butadiene is then lowered by means of selective hydrogenation further to 1000 ppm by weight or less.

19. The process according to claim 15, wherein, in the provision of the technical C₄ hydrocarbon stream used in the polymerization of isobutene, as an additional step III, a hydroformylation of the C₄ hydrocarbon stream obtained from step IIa is carried out in the presence of a customary hydroformylation catalyst with hydrogen and carbon monoxide, and the C₅ aldehydes formed are removed from the resulting C₄ hydrocarbon stream.

20. The process according to claim 19, comprising the further conversion of the C₅ aldehydes formed in the hydroformylation step III to 2-propylheptanol.

21. The process according to claims 16, wherein, when the content of 1,3-butadiene in the C₄ olefin mixture obtained in step Ib is 5% by weight or more, the content of 1,3-butadiene is lowered by means of extractive distillation to a content between 1000 ppm by weight and 5% by weight, and the content of 1,3-butadiene is then lowered by means of selective hydrogenation further to 1000 ppm by weight or less.

22. The process according to claims 16, wherein, in the provision of the technical C₄ hydrocarbon stream used in the polymerization of isobutene, as an additional step III, a hydroformylation of the C₄ hydrocarbon stream obtained from step IIb is carried out in the presence of a customary hydroformylation catalyst with hydrogen and carbon monoxide, and the C₅ aldehydes formed are removed from the resulting C₄ hydrocarbon stream.

23. The process according to claims 22, comprising the further conversion of the C₅ aldehydes formed in the hydroformylation step III to 2-propylheptanol.

24. The process according to claims 17, wherein, when the content of 1,3-butadiene in the C₄ olefin mixture obtained in step Id is 5% by weight or more, the content of 1,3-butadiene is lowered by means of extractive distillation to a content between 1000 ppm by weight and 5% by weight, and the content of 1,3-butadiene is then lowered by means of selective hydrogenation further to 1000 ppm by weight or less.

25. The process according to claims 17, wherein, in the provision of the technical C₄ hydrocarbon stream used in the polymerization of isobutene, as an additional step III, a hydroformylation of the C₄ hydrocarbon stream obtained from step IId is carried out in the presence of a customary hydroformylation catalyst with hydrogen and carbon monoxide, and the C₅ aldehydes formed are removed from the resulting C₄ hydrocarbon stream.

26. The process according to claims 25, comprising the further conversion of the C₅ aldehydes formed in the hydroformylation step III to 2-propylheptanol.

27. The process according to claim 12, comprising, after the polymerization of the isobutene, a metathesis reaction in which the 2-butene-rich C₄ residual stream removed from the isobutene polymerization is contacted with ethene in the presence of a customary metathesis catalyst and the propene is removed from the propene-containing hydrocarbon stream formed.

28. A process for reducing the content of oxygenates in a technical 1-butene-, 2-butene- and isobutene-containing C₄ hydrocarbon stream which may comprise up to 3000 ppm by weight of 1,3-butadiene, which comprises cooling the C₄ hydrocarbon stream at a pressure of from 1 to 40 bar to a temperature of less than 20° C., removing water which separates out and then contacting the C₄ hydrocarbon stream with an inorganic adsorbent at a pressure of from 1 to 40 bar and a temperature of from −40 to +220° C.
